(19) United States
(12) Patent Application Publication
(10) Pub. No.: US 2013/0309634 A1
(43) Pub. Date: Nov. 21, 2013

(54) ROOM ORGANIZER LAYOUT AID

(71) Applicant: Beverly Ann Gaskins-Lucas, Have de Grace, MD (US)

(72) Inventor: Beverly Ann Gaskins-Lucas, Have de Grace, MD (US)

(21) Appl. No.: 13/475,982

(22) Filed: May 19, 2012

(51) Int. Cl. G09B 25/00

(52) U.S. Cl. 434/80

(57) ABSTRACT

A room organizer layout aid can assist a person organize the furniture layout in an empty room prior to the placement of furniture. The room organizer layout aid includes a plurality of light-weight material pieces that may represent the footprint of various furniture items. These material pieces may include measurements formed along at least two edged thereof to allow a user to adjust the size according to the furniture that they desire to place in the room. A bed template may include fold lines to change a king-size material piece to smaller bed sizes, such as queen, full and twin. The room organizer layout aid may be used in various applications. For example, a user may place the material pieces down on their floor to not only get a feel for the furniture layout in a room, but also to show movers where furniture pieces should be placed.

### BACKGROUND OF THE INVENTION

The present invention relates to room layout accessories and methods and more particularly, to a room organizer layout aid that provides a full-size, easily movable sheets for determining furniture position prior to actually moving furniture into a room.

When rooms are empty, it is difficult to judge what size furniture can fit into the room. Prior art room design tools are scaled models that often only provide a birds-eye view of a room design. These scaled models do not give a user a good feel for how it would be to walk about with the furniture in the room, for example. Also, the scaled designs take considerable work to create a layout that approximates a furniture layout, since each furniture piece needs to be scaled accordingly.

As can be seen, there is a need for an improved room design and layout aid that can be used in an empty room to help a user decide where to place furniture.

### SUMMARY OF THE INVENTION

In one aspect of the present invention, a room organizer layout aid comprises a plurality of flexible material pieces adapted to approximate sizes and shapes of actual furniture items; a measuring strip attached to at least two adjacent sides of at least one of the plurality of flexible material pieces; and bedding size indicators attached to at least one of the plurality of flexible material pieces.

In another aspect of the present invention, a room organizer layout kit comprises at least one rectangular/square furniture template adapted to approximate the size and shape of rectangular or square furniture items; a measuring strip attached to at least two adjacent edges of the rectangular/square furniture template; at least one round furniture template; and at least one bed size template, the bed size template having bedding size indicators including width identification markers to indicate widths of king, queen, full and twin sized beds.

In a further aspect of the present invention, a method for organizing a layout of furniture in an empty room comprises disposing a plurality of flexible pieces on a floor of the empty room; adjusting sizes of the flexible pieces to approximate the actual size of the furniture to be placed in the empty room; and moving the flexible pieces about the room to develop a desired layout of the furniture.

These and other features, aspects and advantages of the present invention will become better understood with reference to the following drawings, description and claims.

### BRIEF DESCRIPTION OF THE DRAWINGS

FIG. 1 is a perspective view of a room showing various components of the room layout and design tool in use, according to an exemplary embodiment of the present invention;

FIG. 2 is a perspective view of a rectangular exemplary furniture template used in the room layout shown in FIG. 1;

FIG. 3 is a detailed perspective view of the exemplary furniture item of FIG. 3;

FIG. 4 is a perspective view of an exemplary round furniture template used in the room layout shown in FIG. 1; and

FIG. 5 is a top view of a bed furniture template used in the room layout and design tool according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a room organizer layout aid that can assist a person organize the furniture layout in an empty room prior to the placement of furniture. The room organizer layout aid (ROLA) includes a plurality of light-weight material pieces that may represent the footprint of various furniture items. These material pieces may include measurements formed along at least two edged thereof to allow a user to adjust the size according to the furniture that they desire to place in the room. A bed template may include fold lines to change a king-size material piece to smaller bed sizes, such as queen, full and twin. The ROLA may be used in various applications. For example, a user may place the material pieces down on their floor to not only get a feel for the furniture layout in a room, but also to show movers where furniture pieces should be placed.

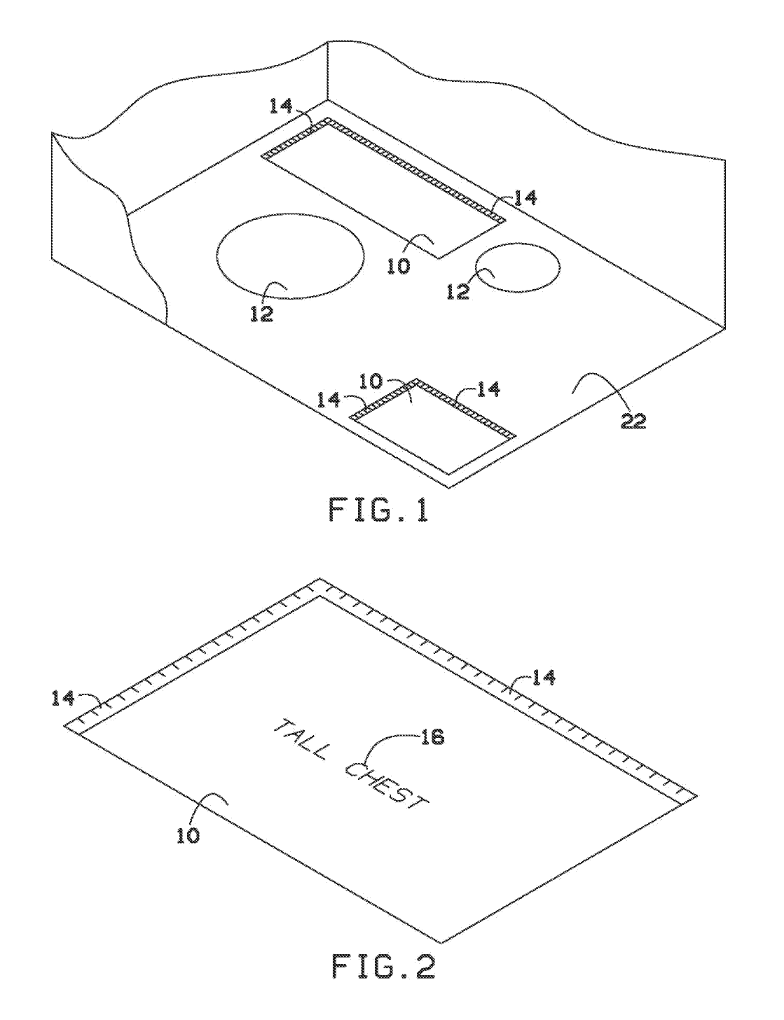

Referring to FIGS. 1 through 5, a plurality of furniture templates may be placed about a room floor 22. For example, a rectangular/square furniture template 10 may be disposed to approximate a size and position for a sofa, a round furniture template 12 may be disposed to approximate a size and position of an end table and/or a coffee table, and another rectangular/square furniture template 10 to approximate the size and position of a tall chest, such as a television stand, for example. As shown in FIG. 1, a complete living room layout may be designed, in the actual living room itself, prior to moving the furniture into place.

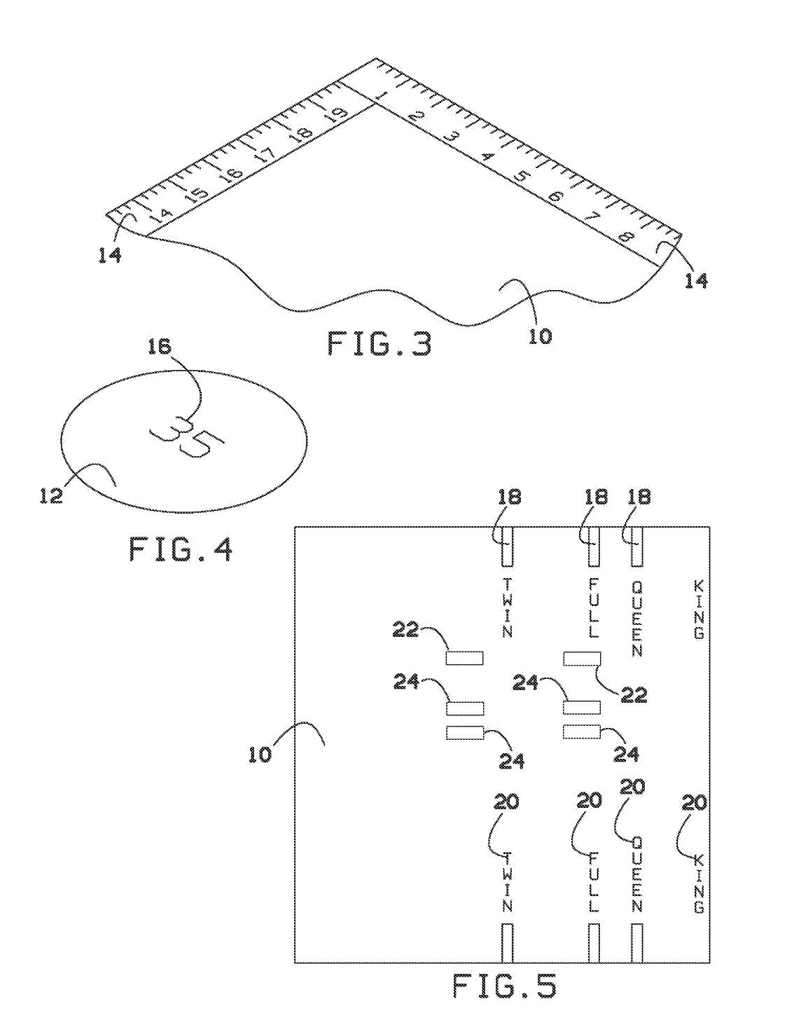

Referring to FIGS. 2 and 3, the rectangular/square furniture templates 10 may include measuring strips 14 disposed on at least two sides thereof. The measuring strips 14 may allow a user to fold the template 10 under itself to adjust the template 10 to the appropriate size.

Referring to FIG. 4, the round furniture template 12 may include a pad identification lettering 16. The identification lettering 16 may be used to match the template 12 to a particular furniture piece, for example. In some embodiments, the identification lettering 16 may represent a diameter of the round furniture template 12.

Referring to FIG. 5, the rectangular/square furniture template 10 may include indicia for bed sizes. In one embodiment, the furniture template 10 may be formed in the size of a king size bed. The template 10 may include width identification markers 18 and lettering 20 to show where a user should fold the template to create the desired bed size. The bed template 10 may include a plurality of hook and loop (such as Velcro®) fasteners attached thereto. Some fasteners 22 may be used to hold a night stand template and a sofa template to the bed size template, for example. Some other fasteners 24 may be used to shorten the bed size template to the length of the a twin bed.

The various templates described above may be made from a flexible material. This material may be, for example, fabric, including natural and synthetic, woven and non-woven fabrics, polymer-based, or the like.

The room organizer layout aid of the present invention may be provided as a kit, containing a plurality of pieces to create a desired room layout design.

To use the room organizer layout aid of the present invention, a user can simply place items in the room until the desired effect is achieved. Since the items approximate the size of the footprint of the actual furniture in the room, the flow of the room can be established as well as the length and width of the furniture needed in the room.

It should be understood, of course, that the foregoing relates to exemplary embodiments of the invention and that modifications may be made without departing from the spirit and scope of the invention as set forth in the following claims.

What is claimed is:

1. A room organizer layout aid comprising:
a plurality of flexible material pieces adapted to approximate sizes and shapes of actual furniture items;
a measuring strip attached to at least two adjacent sides of at least one of the plurality of flexible material pieces; and
bedding size indicators attached to at least one of the plurality of flexible material pieces.

2. The room organizer layout aid of claim 1, wherein the bedding size indicator include width identification markers and lettering to indicate widths of king, queen, full and twin sized beds.

3. The room organizer layout aid of claim 2, wherein the bedding size indicator includes hook and loop fasteners to adjust a length to indicate a twin size bed length.

4. The room organizer layout aid of claim 1, wherein the measuring strip is attached to a rectangular/square furniture template.

5. The room organizer layout aid of claim 1, wherein at least one of the plurality of flexible material pieces includes a round furniture template.

6. The room organizer layout aid of claim 1, wherein the flexible material pieces are made from fabric.

7. A room organizer layout kit comprising:
at least one rectangular/square furniture template adapted to approximate the size and shape of rectangular or square furniture items;
a measuring strip attached to at least two adjacent edges of the rectangular/square furniture template;
at least one round furniture template; and
at least one bed size template, the bed size template having bedding size indicators including width identification markers to indicate widths of king, queen, full and twin sized beds.

8. The room organizer layout aid of claim 7, wherein the bedding size indicator includes hook and loop fasteners to adjust a length to indicate a twin size bed length.

9. A method for organizing a layout of furniture in an empty room, the method comprising:
disposing a plurality of flexible pieces on a floor of the empty room;
adjusting sizes of the flexible pieces to approximate the actual size of the furniture to be placed in the empty room; and
moving the flexible pieces about the room to develop a desired layout of the furniture.

10. The method of claim 9, further comprising adjusting a size of a bed size furniture template to approximate a desired bed size, the bed size template having bedding size indicators including width identification markers to indicate widths of king, queen, full and twin sized beds.
